(19) United States
(12) Patent Application Publication
(10) Pub. No.: US 2002/0095875 A1
(43) Pub. Date: Jul. 25, 2002

(54) Abrasive diamond composite and method of making thereof

(76) Inventors: Mark Philip D'Evelyn, Niskayuna, NY (US); Kristi Jean Narang, Voorheesville, NY (US); James Michael McHale JR., Worthington, OH (US); Michael Hans Loh, Stuttgart (DE); Aaron Wilbur Saak, Gahanna, OH (US); Steven William Webb, Worthington, OH (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(21) Appl. No.: 09/729,525

(22) Filed: Dec. 4, 2000

(51) Int. Cl. C09C 1/68; C09K 3/14

(52) U.S. Cl. 51/309

(57) ABSTRACT

An abrasive diamond composite formed from coated diamond particles and a matrix material. The diamonds have a protective coating formed from a refractory materia1 having a composition MCₓN_{y}, that prevents corrosive chemical attack of the diamonds by the matrix material. The abrasive diamond composite may further include an infiltrant, such as a braze material. Alternatively, the abrasive diamond composite may include a plurality of coated diamond particles and a braze material filling interstitial spaces between the coated diamond particles. Methods of making such abrasive diamond composites are also disclosed.

### BACKGROUND OF THE INVENTION

The present invention relates to an abrasive composite. More particularly, the present invention relates to an abrasive composite formed from coated diamond particles and a matrix material, and a method for making such an abrasive composite. Still more particularly, the present invention relates to an abrasive composite formed from coated diamond particles and a matrix material in which the matrix is infiltrated with a strengthening material. Even more particularly, the present invention relates to a diamond particle having a chemically resistant coating for use in such abrasive composite.

Conventional diamond saw blade segments are fabricated by first blending diamond crystals with a metal powder, typically cobalt, and then hot-pressing the mixture to obtain the desired form. Due to cost considerations, there is considerable interest in substituting other metals for cobalt in the matrix.

Good adhesion of diamonds to the matrix—and the retention of the diamonds therein—is necessary to produce a cutting tool that will have an adequate service lifetime. If adhesion of the diamond crystal to the matrix is not sufficiently strong, the diamond crystals prematurely pull out of the matrix during use. It is therefore desirable to improve the durability of the diamond-matrix bond and to obtain better retention of the diamond crystals in the matrix. One possible means for improving these properties is infiltration of the diamond-metal matrix with a molten braze alloy.

Some metals, such as iron or nickel, react with diamond. The use of these materials in the matrix and in liquid-infiltrated metal bonds may therefore expose the diamond crystals to extremely corrosive conditions. Chemical attack under such conditions may produce pitting on the diamond surface, thereby decreasing the mechanical strength and abrasion resistance of the diamonds.

Diamonds having a variety of outer coatings are well known in the art and are commercially available. Most of the prior-art coatings are intended to improve adhesion. Such coatings have some degree of resistance to chemical attack, but are thinner than about 1 μm. Due to the limited thickness of such coatings, substantial corrosion of the diamonds can still occur. While refractory coatings have been applied to saw-grade diamonds, they have not been used in conjunction with metal-based, liquid-infiltrated bonded diamond composites. In addition, the prior art fails to address a metal-based matrix that is substantially free of additional hard constituents.

Diamond composite materials having liquid-infiltrated metal bonds are denser and more durable than similar materials having conventional hot-pressed bonds. Liquid-infiltrated composites found in the prior art, however, are of limited use, as diamonds undergo substantial degradation due to corrosion by the liquid infiltrant. Therefore, what is needed is a diamond composite material in which the diamonds are capable of resisting corrosion by either a matrix material or an infiltrating material. In addition, what is needed is a diamond composite material that offers excellent retention of the diamonds in the matrix. What is further needed is a method of making such a diamond composite material. Finally, what is needed is a coated diamond particle for use in an abrasive diamond composite that is resistant to corrosive attack by either the matrix or infiltrating materials.

### BRIEF SUMMARY OF THE INVENTION

The present invention satisfies these needs and others by providing an abrasive composite formed from a matrix material and diamonds having a corrosion-resistant coating. Additionally, the abrasive composite of the present invention may include a braze material which, as a liquid, infiltrates the matrix, thereby forming a composite that is denser and more durable than similar materials having conventional hot-pressed bonds. A method of making these composite materials, as well as a diamond particle for use in the abrasive composite material and having a corrosion-resistant coating, are also within the scope of the invention.

Accordingly, one aspect of the present invention is to provide an abrasive diamond composite. The abrasive diamond composite comprises a plurality of coated diamond particles, each of the coated diamond particles comprising a diamond having an outer surface and a protective coating disposed on the outer surface; and a matrix material disposed on each of the coated diamond particles and interconnecting the coated diamond particles. The matrix material comprises at least one of a metal carbide and a metal, and the protective coating protects the diamond from corrosive chemical attack by the matrix material.

A second aspect of the present invention is to provide a coated diamond particle for forming an abrasive diamond composite, the abrasive diamond composite comprising a matrix material and a plurality of coated diamond particles. The coated diamond particle comprises a diamond having an outer surface and a protective coating disposed on the outer surface. The protective coating comprises a refractory material and protects the diamond particle from corrosive chemical attack by the matrix material.

A third aspect of the present invention is to provide an abrasive diamond composite. The abrasive diamond composite comprises: a plurality of coated diamond particles, each of the coated diamond particles comprising a diamond having an outer surface and a protective coating disposed on the outer surface, the protective coating comprising a refractory material having the formula MCₓN_{y}, wherein M is a metal, C is carbon having a first stoichiometric coefficient x, and N is nitrogen having a second stoichiometric coefficient y wherein 0≦x, y≦2; and a matrix material comprising at least one of a metal carbide and a metal, the matrix material being disposed on each of the coated diamond particles and interconnecting the coated diamond particles and forming a skeleton structure containing a plurality of voids and open pores, with the protective coating protecting the diamond from corrosive chemical attack by the matrix material; and a braze infiltrated through the matrix material and occupying the voids and open pores.

A fourth aspect of the present invention is to provide an abrasive diamond composite comprising: a plurality of coated diamond particles, each of the coated diamond particles comprising a diamond having an outer surface and a protective coating disposed on the outer surface, the protective coating comprising a refractory material having a formula MCₓN_{y}, wherein M is a metal, C is carbon having a first stoichiometric coefficient x, and N is nitrogen having a second stoichiometric coefficient y, and wherein 0≦x, y≦2; and a braze infiltrating and filling interstitial spaces between the coated diamond particles, thereby interconnecting the coated diamond particles.

A fifth aspect of the present invention is to provide a method for making an abrasive diamond composite for use in an abrasive tool. The method comprises the steps of: providing a plurality of diamonds; applying a protective coating to an outer surface of each of the diamonds, thereby forming a plurality of coated diamond particles; combining a matrix material with the plurality of coated diamond particles to form a pre-form; and heating the pre-form to a predetermined temperature, thereby forming an abrasive diamond composite.

Finally, a sixth aspect of the present invention is to provide a method for making a liquid-infiltrated abrasive diamond composite for use in an abrasive tool. The method comprises the steps of: providing a plurality of diamonds; applying a protective coating to an outer surface of each of the diamonds, thereby forming a plurality of coated diamond particles; combining a matrix material with the plurality of coated diamond particles to form a pre-form in which the matrix material forms a skeleton structure containing a plurality of voids and open pores; placing a braze alloy in contact with the pre-form; heating the braze alloy and the pre-form to a predetermined temperature above a melting temperature of the braze alloy, thereby creating a molten braze alloy; and infiltrating the molten braze alloy through the matrix material and occupying the plurality of voids and open pores with the molten braze alloy, thereby forming the liquid-infiltrated abrasive diamond composite.

The liquid-infiltrated, abrasive diamond composite can be used as a saw-blade segment, a crown drilling bit, or other abrasive tool.

These and other aspects, advantages, and salient features of the invention will become apparent from the following detailed description, the accompanying drawings, and the appended claims.

### BRIEF DESCRIPTION OF THE DRAWINGS

FIG. 1 is a schematic cross-sectional representation of a diamond particle having a protective coating according to the present invention;

FIG. 2 is a cross-sectional schematic representation of a coated diamond particle and matrix pre-form according to the present invention;

FIG. 3 is a cross-sectional schematic representation of a pre-form and infiltrating braze prior to infiltration;

FIG. 4 is a cross-sectional schematic representation of an liquid-infiltrated abrasive diamond composite of the present invention;

FIG. 5 is an optical micrograph of uncoated diamonds recovered after mixing with carbonyl iron powder and free-sintering at 850° C. in a hydrogen atmosphere for one hour;

FIG. 6 is an optical micrograph of diamonds having a WC coating approximately 1.3 μm thick, recovered after mixing with iron powder and free-sintering at 850° C. in hydrogen for one hour;

FIG. 7 is an optical micrograph of diamonds having a SiC coating approximately 5 μm thick, recovered after mixing with iron powder and free-sintering at 850° C. in hydrogen for one hour

FIG. 8 is a scanning electron microscopy (SEM) micrograph of uncoated diamonds after mixing with iron powder and infiltrating with 60Cu-40Ag at 1100° C. for 5 minutes;

FIG. 9 is a SEM micrograph of diamonds with a WC coating approximately 9 μm thick, after mixing with iron powder and infiltrating with 60Cu-40Ag at 1100° C. for 5 minutes;

FIG. 10 is a SEM micrograph of uncoated diamonds after mixing with tungsten powder and infiltrating with 53Cu-24Mn-15Ni-8Co at 1100° C. for 10 minutes;

FIG. 11 is a SEM micrograph of diamonds with a WC coating, approximately 9 μm thick, after mixing with tungsten powder and infiltrating with 53Cu-24Mn-15Ni-8Co at 1100° C. for 10 minutes;

FIG. 12 is a SEM micrograph of diamonds with a SiC coating, approximately 5 μm thick, after mixing with iron powder and infiltrating with 60Cu-40Ag at 1100° C. for 5 minutes; and

FIG. 13 is a SEM micrograph of diamonds with a TiN coating approximately 5 μm thick, after mixing with iron powder and infiltrating with 6Cu-40Ag at 1100° C. for 5 minutes;

### DETAILED DESCRIPTION OF THE INVENTION

In the following description, like reference characters designate like or corresponding parts throughout the several views shown in the figures. It is also understood that terms such as “top,” “bottom,” “outward,” “inward,” and the like are words of convenience and are not to be construed as limiting terms.

Referring to the drawings in general, it will be understood that the illustrations are for the purpose of describing an embodiment of the invention and are not intended to limit the invention thereto.

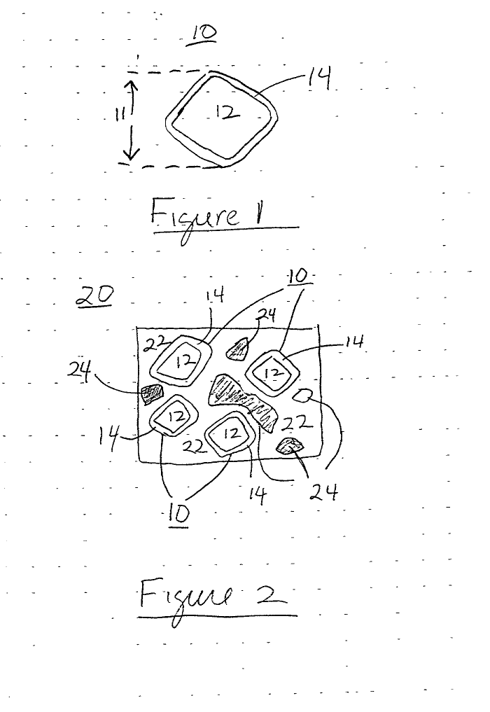

FIG. 1 is a schematic cross-sectional representation of a coated diamond particle 10 according to the present invention. The coated diamond particle 10 includes a diamond 12 and a protective coating 14 deposited on the diamond 12. The coated diamond particle 10 has a major dimension 11, which represents the maximum cross-section of the coated diamond particle 10. The protective coating 14 has the composition MCₓN_{y}, where M represents at least one metal selected from the group consisting of aluminum, silicon, scandium, titanium, vanadium, chromium, yttrium, zirconium, niobium, molybdenum, hafnium, tantalum, tungsten, rhenium, the rare earth metals, and combinations thereof. The stoichiometric coefficients of carbon and nitrogen are x and y, respectively, where 0≦x,y≦2.

The protective coating 14 must be sufficiently thick to provide adequate protection of the diamond 12 from corrosive chemical attack. A thin coating will either rapidly erode away or allow an excessive amount of corrosive matrix material to diffuse through the barrier and attack the diamond. A protective coating 14 that is too thick, on the other hand, will tend to delaminate or crack, due in part to the mismatch in the respective thermal expansion coefficients and hardnesses of the diamond 12 and the protective coating 14. The thickness of the protective coating 14 in the present invention is between about 1 and about 50 microns, and desirably between about 1 and about 20 microns. To achieve the best balance between protection from corrosive attack and coating integrity, a protective coating having a thickness of between about 3 and about 15 microns is preferred.

The major dimension 11 of the coated diamond particles 10 is in the range of between about 50 and about 2000 microns. In order to be useful in most cutting tool and saw applications, it is desirable that the coated diamond particles 10 have an average diameter between about 150 and about 2000 microns, and most preferably between about 180 and about 1600 microns. The protective coating 14 can be deposited by a number of techniques, including, but not limited to, chemical vapor deposition, chemical transport reactions, or by metal deposition followed by either carburization or nitridation of the deposited metal layer. In the latter case, carburization and nitridation of the deposited metal layer may be carried out simultaneously or, alternatively, in succession of each other.

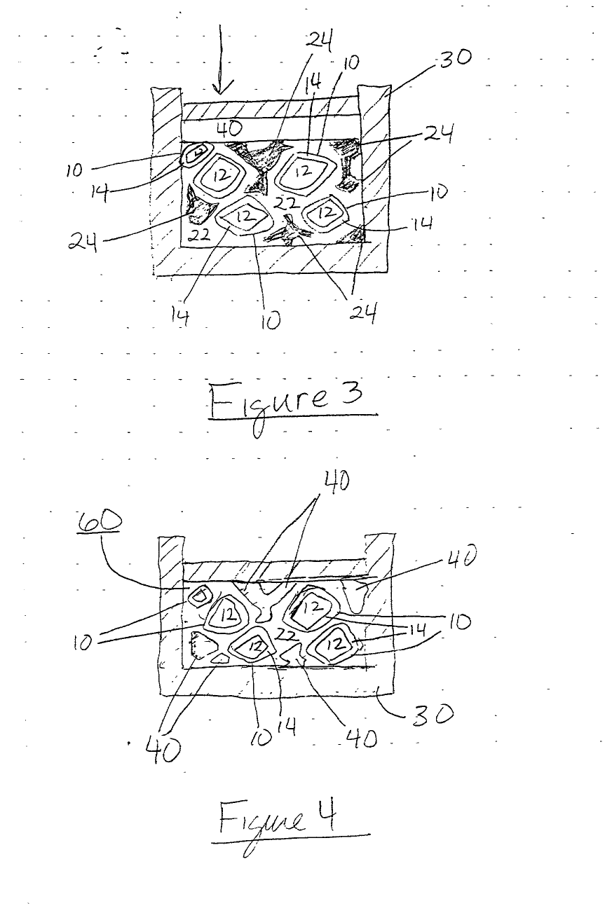

The coated diamond particles 10 are then mixed with a matrix material 22 to form a composite mixture 20, which is schematically shown in FIG. 2. The coated diamond particles 10 are mixed with the matrix material to achieve a uniform distribution of coated diamond particles 10 throughout the composite mixture 20; i.e., the coated diamond particles 10 are evenly distributed throughout the composite mixture 20. The matrix material 22 contacts the coated diamond particles 10, interconnecting the coated diamond particles 10 while at the same time creating a skeleton-like structure having voids and open pores 24 within the composite mixture 20.

In order to provide a cutting tool having sufficient cutting strength, the coated diamond particles 10 must comprise a sufficient volume fraction of the composite mixture 20. In addition, a sufficient number of diamonds must lie exposed on the cutting surface of the tool. A volume fraction of coated diamond particles within the composite mixture 20 that is below a threshold limit results in too low a number of coated diamond particles 10 exposed on the cutting surface of the tool. This results in a decrease in the effectiveness of the cutting tool beyond the point of being useful. Conversely, if the volume fraction of coated diamond particles 10 in the composite mixture 20 is too high, retention of the coated diamond particles 10 in the composite mixture 20 decreases due to the correspondingly lower amount of matrix material 22 present in the composite mixture 20. A cutting tool having a volume fraction of coated diamond particles 10 that is above an upper limit will not retain coated diamond particles 10 and thus fail. In the present invention, the coated diamond particles 10 comprise between about 1 and about 50 volume percent, and preferably between about 5 and about 20 volume percent of the composite mixture 20.

The matrix material 22 is a powdered material, and may comprise iron, cobalt, nickel, manganese, steel, molybdenum, tungsten, metal carbides, mixtures thereof, and alloys thereof. The matrix material 22 preferably includes at least 5 weight percent of at least one of iron and manganese. To provide the best combination of packing density, dispersion qualities, and chemical purity, the particle size of the matrix material 22 is between about 1 and about 50 microns. The matrix material 22 comprises between about 5 and about 99 weight percent of the composite mixture 20 that forms the abrasive diamond composite. To improve the durability and abrasion-resistance of the matrix and the overall cost of the abrasive diamond composite, the matrix material 22 preferably includes at least about 5 weight percent of at least one of iron and manganese.

A pre-form is created by placing the composite mixture 20 in a mold 30, as depicted in FIG. 3. In one embodiment of the invention, a graphite mold is used. Other suitable materials can also be used to construct the mold 30. An abrasive diamond composite comprising the coated diamond particles 10 and the matrix material 22 can then be formed by hot-pressing the pre-form. Generally, pressures between about 1000 psi and about 20,000 psi and temperatures between about 600° C. and about 1100° C. are used to hot-press the pre-form into a fully dense composite shape. Pressures in the range of between about 4000 psi and about 6000 psi and temperatures in the range of between about 750° C. and about 900° C. are preferably used to convert the pre-form into a fully dense abrasive diamond composite.

The abrasive diamond composite can be further strengthened by infiltrating the skeleton structure formed by the matrix material 22 with a molten metal. Liquid infiltration can be performed by either pressing the pre-form as described above prior to infiltration, or by using a loose-packed composite mixture 20 of matrix material 22 and coated diamonds 10. The liquid-infiltrated composite is formed by placing an infiltrant metal 40 on top of the pre-form. The infiltrant metal 40 is typically a braze alloy that comprises at least one metal selected from the group consisting of copper, silver, zinc, nickel, cobalt, manganese, tin, cadmium, indium, phosphorus, gold, or palladium, and preferably includes at least 5 weight percent of at least one metal from the group consisting of cobalt, nickel, manganese, and iron. The mold 30 containing the mixture 22 and infiltrant metal 40 is then placed in a furnace and heated to a temperature which is sufficiently high to melt the braze alloy. The temperature is preferably between about 800° C. and about 1200° C. The mold is preferably held at temperature for 1 to 20 minutes. The molten braze alloy infiltrates the coated diamond and matrix pre-form by capillary action, filling any voids and open porosity in the skeleton structure, thereby forming a dense body 60, shown in FIG. 4. The braze material 40 comprises between about 5 and about 99 weight percent of the liquid-infiltrated abrasive diamond composite 60. After the mold assembly is removed from the furnace and allowed to cool, the liquid-infiltrated abrasive diamond composite part 60 is removed from the mold 30.

The liquid-infiltrated, diamond-impregnated part is useful as a saw-blade segment, a crown drilling bit, or other abrasive tool.

### EXAMPLE 1

A 0.3 g quantity of commercially available, uncoated, high-grade saw diamond crystals was mixed with 6 g of commercial grade carbonyl iron powder and placed in an alumina boat. The boat was then placed in a furnace and heated to 850° C. in a hydrogen atmosphere for a period of one hour. After removal from the furnace and cooling, diamonds were recovered from a portion of the free-sintered part by boiling in aqua regia, 1:1 HF/HNO ₃, and 9:1 H₂SO₄/HNO₃ in succession.

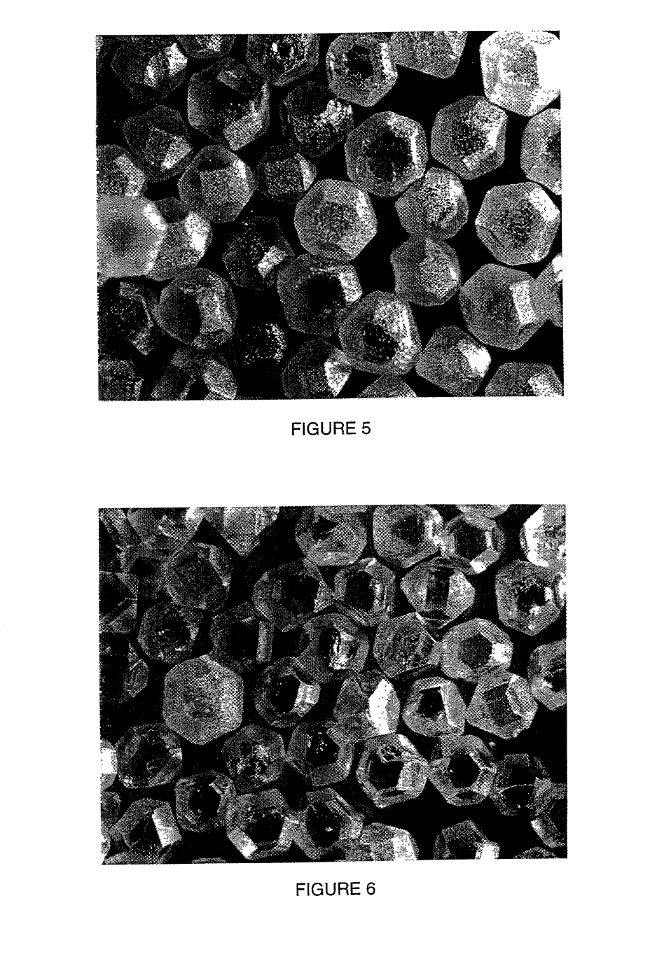

The recovered diamonds were then examined by optical microscopy to assess the extent of chemical attack. The recovered uncoated diamonds are shown in FIG. 5. As can be seen from the micrograph, a substantial degree of etching of the uncoated diamonds in the iron matrix was observed.

The relative diamond-to-matrix adhesion and retention were assessed by measuring the difference in the apparent hardness on top of a diamond in the matrix versus the hardness of the matrix itself. The surface of an abrasive diamond/matrix composite is ground to a finish of about 20 μm flatness using a conventional diamond grinding wheel. This grinding process fractures diamond crystals that would otherwise have protruded from the newly-exposed surface. Indentations are created with a blunted 120° diamond indentor and a 60 kg load, either on top of exposed diamonds or on diamond-free matrix material. The Rockwell C hardness is then evaluated from the diameter of the indents. If adhesion to the diamond is poor, a bound diamond —or diamonds —under the indentor tip will act as a sharp point pressing into the matrix, increasing the total indent depth and decreasing the apparent hardness relative to the matrix itself. If adhesion to the diamond is good, the load from the indentor tip is transmitted to the matrix and the apparent hardness is similar or even slightly greater than the hardness of the matrix itself.

The retention of the uncoated diamonds in the free-sintered iron composite part was evaluated by differential-hardness testing performed according to the method described above. The apparent hardness was evaluated on top of four uncoated diamonds that were exposed by grinding the surface of the part. The apparent hardness was then compared to the hardness of the iron matrix, which was also measured at four points. The means and standard deviations of the Rockwell C hardness values that were evaluated from the indentations are listed in Table 1. The apparent hardness of the matrix below the uncoated diamonds was 5 points lower than that of the matrix itself, indicating a degree of retention in the bond that is normally observed for diamond cutting tools.

### EXAMPLE 2

Commercially available, high-grade saw diamond crystals were coated with tungsten carbide (WC). The WC coating thickness was about 1.3 μm. A 0.3 g quantity of the coated diamonds was then mixed with 6 g of commercial grade carbonyl iron powder and placed in an alumina boat. The boat was then placed in a furnace and heated to 850° C. in a hydrogen atmosphere for a period of one hour. After removal from the furnace and cooling, diamonds were recovered from a portion of the free-sintered part by boiling in aqua regia, 1:1 HF/HNO₃, and 9:1 H₂SO₄/HNO₃ in succession.

The recovered diamonds were then examined by optical microscopy to assess the extent of chemical attack. The recovered coated diamonds are shown in FIG. 6. In contrast to the appearance of the uncoated diamonds (FIG. 5), no etching of the WC-coated diamonds by the iron matrix was observed, demonstrating that the resistance of the diamonds to corrosive chemical attack was increased by the presence of the WC coating on the diamonds.

The retention of the diamonds coated with WC in the free-sintered iron composite part was evaluated by differential-hardness testing performed according to the previously described method. The means and standard deviations of the Rockwell C hardness values evaluated from the indentations on the matrix and above diamonds coated with WC are listed in Table 1. The apparent hardness of the matrix below the diamonds coated with WC was 6 points higher than that of the matrix itself, indicating improved retention of the WC-coated diamonds in the Fe matrix relative to that of the uncoated diamonds.

### EXAMPLE 3

Commercially available, high-grade saw diamond crystals were coated with silicon carbide (SiC). The SiC coating thickness was about 5 μm. A 0.3 g quantity of the coated diamonds was then mixed with 6 g of commercial grade carbonyl iron powder and placed in an alumina boat. The boat was then placed in a furnace and heated to 850° C. in a hydrogen atmosphere for a period of one hour. After removal from the furnace and cooling, diamonds were recovered from a portion of the free-sintered part by boiling in aqua regia, 1:1 HF/HNO₃, and 9:1 H₂SO₄HNO₃ in succession.

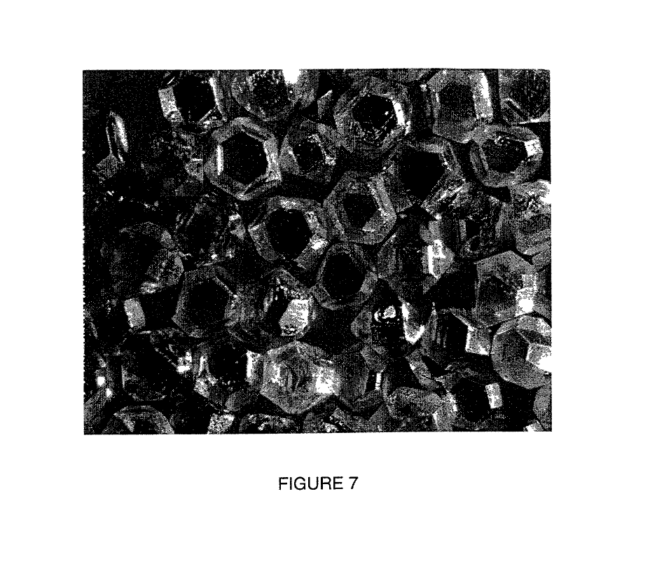

The recovered diamonds were then examined by optical microscopy to assess the extent of chemical attack. The recovered coated diamonds are shown in FIG. 7. In contrast to the appearance of the uncoated diamonds (FIG. 5), no etching of the SiC-coated diamonds by the iron matrix was observed, demonstrating that that the resistance of the diamonds to corrosive chemical attack was increased by the presence of the SiC coating.

The retention of the diamonds coated with SiC in the free-sintered iron composite part was evaluated by differential-hardness testing. The means and standard deviations of the Rockwell C hardness values evaluated from the indentations on the matrix and above diamonds coated with SiC are listed in Table 1. The apparent hardness of the matrix below the diamonds coated with SiC was 5 points higher than that of the matrix, indicating improved retention of the SiC-coated diamonds in the Fe matrix relative to that of the uncoated diamonds.

TABLE 1
Summary of performance of uncoated and coated
diamond in free-sintered iron bonds.

| | Mean Rockwell C Hardness | | | |
|---|---|---|---|---|
| Diamond | (60 kg load) | | | Morphology of |
| sample | Matrix | Diamond | Difference | recovered diamonds |
| 1. Uncoated | 51.8 | 46.5 | −5.3 | Etched |
| 2. WC, 1.3 μm | 44.0 | 50.3 | 6.3 | No etching |
| 3. SiC, 5 μm | 52.3 | 57.5 | 5.2 | No etching |

### EXAMPLE 4

Commercially available, high-grade saw diamond crystals were coated with tungsten carbide (WC). The tungsten carbide coating thickness was about 9 μm. The coated diamonds were then mixed with 1.21 g of commercial-grade iron powder and placed in a graphite mold. Similarly, uncoated diamonds were mixed with 1.21 g of commercial-grade iron powder and placed in a second graphite mold. Each pre-form was then covered by 1.30 g of 60Cu-40Ag (Handy-Harman #24-866) braze material and the mold assemblies were then inserted into a tube furnace held at 1100° C. under an argon atmosphere for 5 minutes. After the mold assemblies were removed from the furnace and allowed to cool, the diamonds were recovered from the liquid-infiltrated parts by boiling in aqua regia, 1:1 HF:HNO₃, and 9:1 H₂SO₄/HNO₃, in succession.

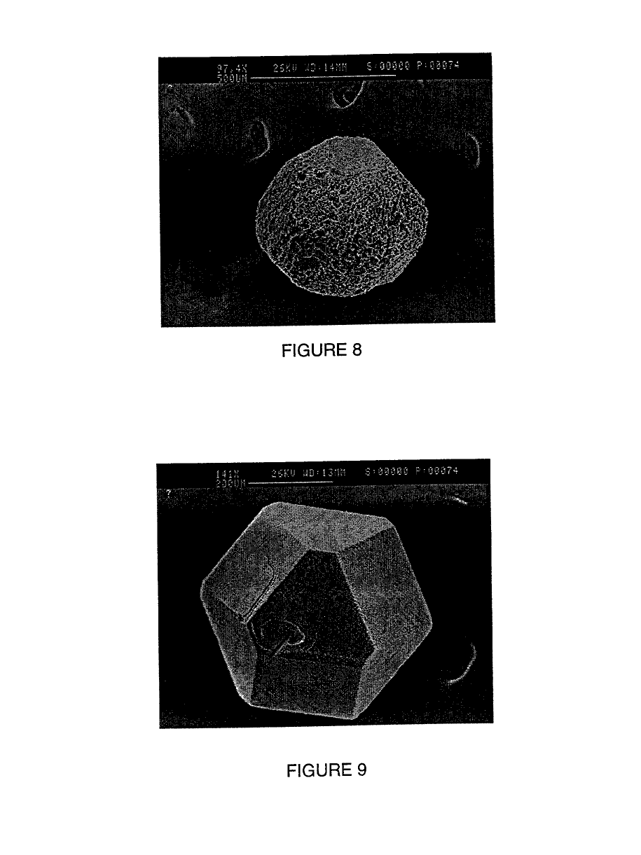

The recovered diamonds were then examined by scanning electron microscopy (SEM) to assess the extent of chemical attack. The recovered uncoated and coated diamonds are shown in FIGS. 8 and 9, respectively. As can be seen from the micrographs, the degree of etching observed for the WC-coated diamonds is reduced relative to that of the uncoated diamonds, demonstrating that the resistance of the diamonds to corrosive chemical attack was increased by the presence of the WC coating on the diamonds.

### EXAMPLE 5

Commercially available, high-grade saw diamond crystals were coated with tungsten carbide (WC). The tungsten carbide coating thickness was about 9 μm. The coated diamonds were then mixed with 2.98 g of tungsten powder and placed in a graphite mold. Similarly, uncoated diamonds were mixed with 2.98 g of tungsten powder and placed in a second graphite mold. Each pre-form was then covered by 1.48 g of 53Cu-24Mn-15Ni-8Co (Handy-Harman #24-857) braze material. The mold assemblies were then inserted into a tube furnace held at 1100° C. under an argon atmosphere for 10 minutes. After the mold assemblies were removed from the furnace and allowed to cool, the diamonds were recovered from the liquid-infiltrated parts by boiling in aqua regia, 1:1 HF:HNO₃, and 9:1 H₂SO₄/HNO₃, in succession.

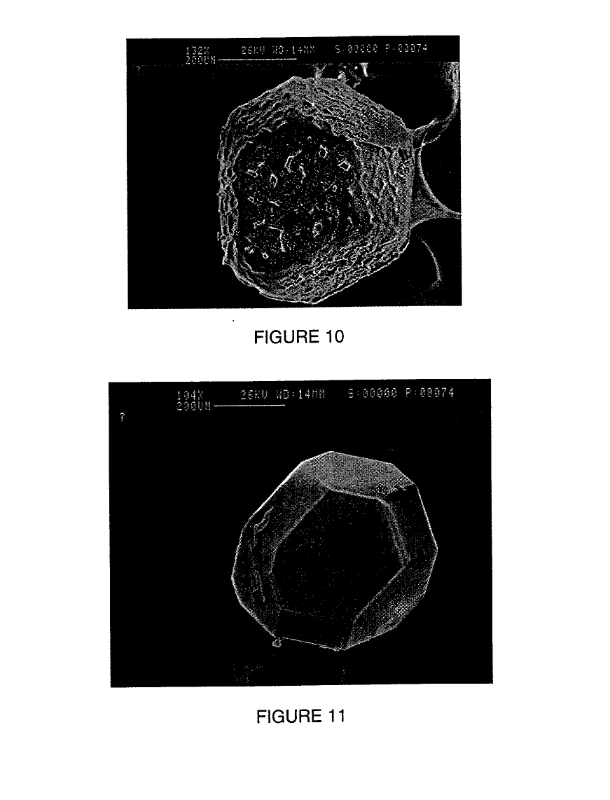

The recovered diamonds were then examined by scanning electron microscopy (SEM) to assess the extent of chemical attack. The recovered uncoated and coated diamonds are shown in FIGS. 10 and 11, respectively. As can be seen from the SEM micrographs, the degree of etching observed for the WC-coated diamonds is greatly reduced relative to that of the uncoated diamonds, demonstrating that the resistance of the diamonds to corrosive chemical attack was increased by the presence of the WC coating on the diamonds.

### EXAMPLE 6

Commercially available, high-grade saw diamond crystals were coated with silicon carbide (SiC). The thickness of the SiC coatings was about 5 μm. The coated diamonds were then mixed with 1.22 g of commercial grade iron powder and placed in a graphite mold. The pre-forms were then covered by 1.32 g of 60Cu-40Ag (Handy-Harman #24-866) braze material. The mold assemblies were then inserted into a tube furnace held at 1100° C. under an argon atmosphere for 5 minutes. After the mold assemblies were removed from the furnace and allowed to cool, the diamonds were recovered from the liquid-infiltrated parts by boiling in aqua regia, 1:1 HF:HNO₃, and 9:1 H₂SO₄/HNO₃, in succession.

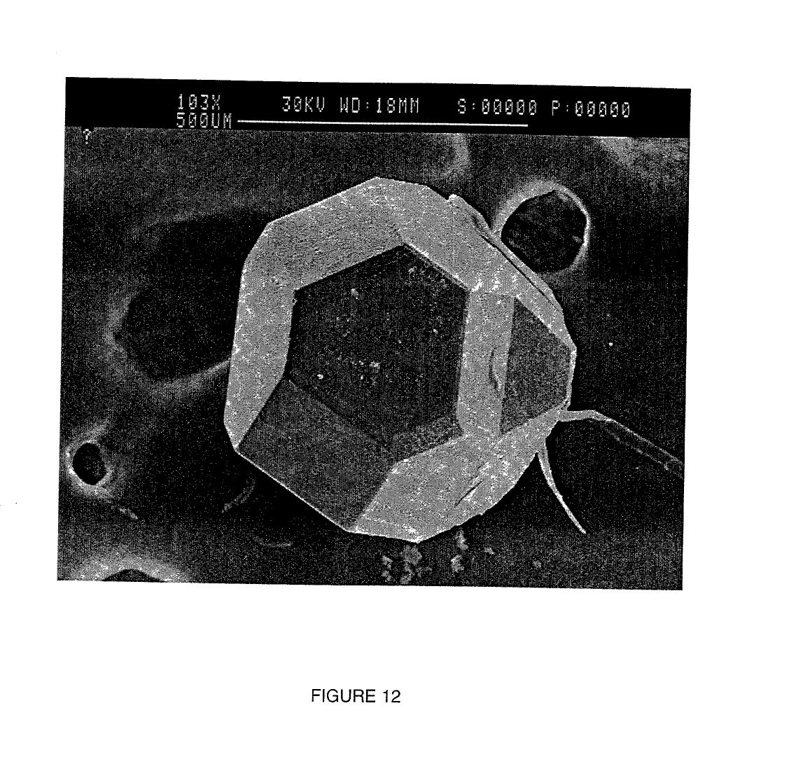

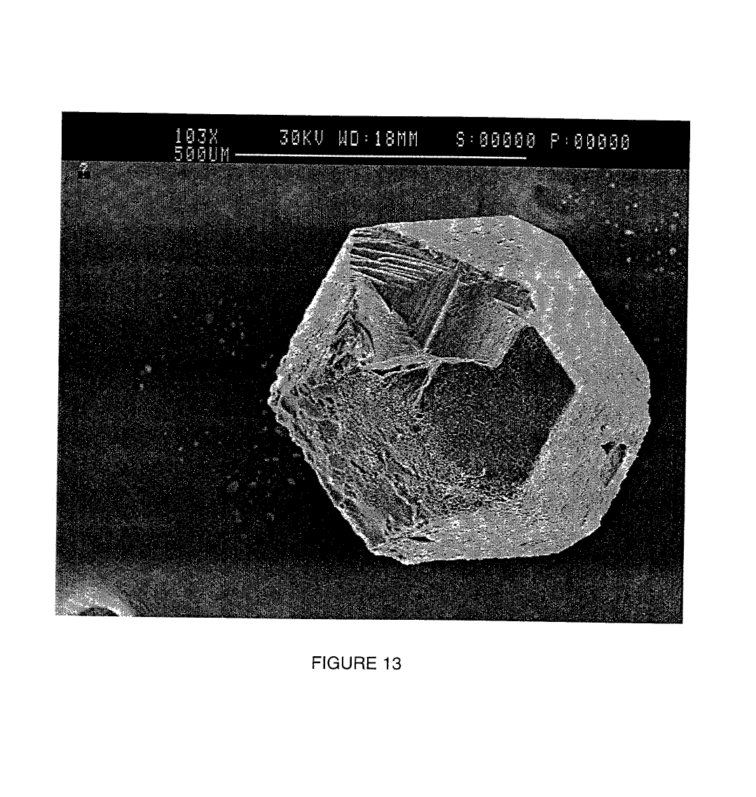

The recovered diamonds were then examined by scanning electron microscopy to assess the extent of chemical attack. The SiC-coated diamonds that were recovered from the liquid-infiltrated parts are shown in FIG. 12. The recovered uncoated diamonds had substantially the same appearance as the uncoated diamonds shown in FIG. 8. As can be seen from the SEM micrographs, the degree of etching of the coated diamonds (FIG. 13) is greatly reduced relative to that observed for uncoated diamonds (FIG. 8), demonstrating that the resistance of the diamonds to corrosive chemical attack was increased by the presence of the SiC coating on the diamonds.

### EXAMPLE 7

Commercially available, high-grade saw diamond crystals were coated with titanium nitride (TiN). The thickness of the TiN coatings was about 5 μm. The coated diamonds were then mixed with 1.23 g of commercial grade iron powder and placed in a graphite mold. The pre-forms were then covered by 1.32 g of 60Cu-40Ag (Handy-Harman #24-866) braze material. The mold assemblies were then inserted into a tube furnace held at 1100° C. under an argon atmosphere for 5 minutes. After the mold assemblies were removed from the furnace and allowed to cool, the diamonds were recovered from the liquid-infiltrated parts by boiling in aqua regia, 1:1 HF:HNO₃, and 9:1 H₂SO₄/HNO₃, in succession.

The recovered diamonds were then examined by scanning electron microscopy to assess the extent of chemical attack. The recovered TiN-coated diamonds are shown in FIG. 13. The recovered uncoated diamonds had substantially the same appearance as the uncoated diamonds shown in FIG. 8. As can be seen from the SEM micrographs, the degree of etching of the coated diamonds (FIG. 11) is significantly reduced relative to that observed for uncoated diamonds (FIG. 8), demonstrating that the resistance of the diamonds to corrosive chemical attack was increased by the presence of the TiN coating on the diamonds.

While various embodiments are described herein, it will be appreciated from the specification that various combinations of elements, variations or improvements therein may be made by those skilled in the art, and are within the scope of the invention. For example, the present invention contemplates the formation a liquid-infiltrated abrasive diamond composite in the absence of the matrix material. In this embodiment, the abrasive diamond composite comprises a plurality of coated diamond particles, each having a protective coating formed from a refractory material having the formula MCₓN_{y}, and a braze, the braze infiltrating and filling interstitial spaces between the coated diamond particles. The use of alternate forming methods, such as hot isostatic pressing, free-sintering, hot coining, and brazing to form the abrasive diamond composite is also within the scope of the invention.

What is claimed is:

1. An abrasive diamond composite, said abrasive diamond composite comprising:
a) a plurality of coated diamond particles, each of said coated diamond particles comprising a diamond having an outer surface and a protective coating disposed on said outer surface; and
b) a matrix material disposed on each of said coated diamond particles and interconnecting said coated diamond particles, said matrix material comprising at least one of a metal carbide and a metal, and said protective coating protecting said diamond from corrosive chemical attack by said matrix material.

2. The abrasive diamond composite of claim 1, wherein said matrix material forms a skeleton structure containing a plurality of voids and open pores, and wherein said abrasive diamond composite further includes a braze infiltrated through said matrix material and occupying said voids and open pores in said skeleton structure.

3. The abrasive diamond composite of claim 2, wherein said braze comprises at least one material selected from the group consisting of copper, silver, zinc, nickel, cobalt, manganese, tin, cadmium, indium, phosphorus, gold, and palladium.

4. The abrasive diamond composite of claim 3, wherein said braze comprises between about 5 weight percent and about 99 weight percent of said abrasive diamond composite.

5. The abrasive diamond composite of claim 3, wherein said braze further includes at least 5 weight percent of at least one metal selected from the group consisting of cobalt, nickel, manganese, and iron.

6. The abrasive diamond composite of claim 1, wherein said matrix material is selected from the group consisting of iron, cobalt, nickel, manganese, steel, molybdenum, tungsten, metal carbides, mixtures thereof, and alloys thereof.

7. The abrasive diamond composite of claim 6, wherein said matrix material includes at least 5 weight percent of at least one metal selected from the group consisting of iron and manganese.

8. The abrasive diamond composite of claim 6, wherein said matrix material comprises between about 5 weight percent and about 99 weight percent of said abrasive diamond composite.

9. The abrasive diamond composite of claim 1, wherein said plurality of coated diamond particles comprises between about 1 volume percent and about 50 volume percent of said abrasive diamond composite.

10. The abrasive diamond composite of claim 9, wherein said plurality of coated diamond particles comprises between about 5 volume percent and about 20 volume percent of said abrasive diamond composite.

11. The abrasive diamond composite of claim 1, wherein each of said coated diamond particles has a major dimension of between about 50 microns and about 2000 microns.

12. The abrasive diamond composite of claim 11, wherein said major dimension is between about 150 microns and about 2000 microns.

13. The abrasive diamond composite of claim 12, wherein said major dimension is between about 180 microns and about 1600 microns.

14. A coated diamond particle for forming an abrasive diamond composite, said abrasive carbon composite comprising a matrix material and a plurality of coated diamond particles, said coated diamond particle comprising:
a) a diamond having an outer surface; and
b) a protective coating disposed on said outer surface, said protective coating comprising a refractory material having a formula MCₓN_{y}, wherein M is a metal, C is carbon having a first stoichiometric coefficient x, and N is nitrogen having a second stoichiometric coefficient y, and wherein 0≦x, y≦2, and wherein said protective coating protects said diamond from corrosive chemical attack by said matrix material.

15. The coated diamond particle of claim 14, wherein said coated diamond particle has a major dimension of between about 50 microns and about 2000 microns.

16. The coated diamond particle of claim 15, wherein said major dimension is between about 150 microns and about 2000 microns.

17. The coated diamond particle of claim 16, wherein said major dimension is between about 180 microns and about 1600 microns.

18. The coated diamond particle of claim 14, wherein said metal M is selected from the group consisting of aluminum, silicon, scandium, titanium, vanadium, chromium, yttrium, zirconium, niobium, molybdenum, hafnium, tantalum, tungsten, rhenium, the rare earth metals, and combinations thereof.

19. The coated diamond particle of claim 14, wherein said protective coating has a thickness of between about 1 micron and about 50 microns.

20. The coated diamond particle of claim 19, wherein said thickness is between about 1 micron and about 20 microns.

21. The coated diamond particle of claim 20, wherein said thickness is between about 3 microns and about 15 microns.

22. An abrasive diamond composite, said abrasive diamond composite comprising:
a) a plurality of coated diamond particles, each of said coated diamond particles comprising a diamond having an outer surface and a protective coating disposed on said outer surface, said protective coating being formed from a refractory material having the formula MCₓN_{y}, wherein M is a metal, C is carbon having a first stoichiometric coefficient x, and N is nitrogen having a second stoichiometric coefficient y, and wherein 0≦x, y≦2; and
b) a matrix material disposed on each of said coated diamond particles, said matrix material interconnecting said coated diamond particles and forming a skeleton structure containing a plurality of voids and open pores, said matrix material comprising at least one of a metal carbide and a metal, said protective coating protecting said diamond from corrosive chemical attack by said matrix material; and
c) a braze infiltrated through said matrix material and occupying said voids and open pores.

23. The abrasive diamond composite of claim 22, wherein said braze comprises at least one material selected from the group of copper, silver, zinc, nickel, cobalt, manganese, tin, cadmium, indium, phosphorus, gold, and palladium.

24. The abrasive diamond composite of claim 23, wherein said braze further includes at least 5 weight percent of at least one metal from the group consisting of cobalt, nickel, manganese, and iron.

25. The abrasive diamond composite of claim 22, wherein said braze comprises between about 5 weight percent and about 99 weight percent of said abrasive diamond composite.

26. The abrasive diamond composite of claim 22, wherein said matrix material is selected from the group consisting of iron, cobalt, nickel, manganese, steel, molybdenum, tungsten, metal carbides, mixtures thereof, and alloys thereof.

27. The abrasive diamond composite of claim 26, wherein said matrix material includes at least 5 weight percent of at least one metal selected from the group consisting of iron and manganese.

28. The abrasive diamond composite of claim 26, wherein said matrix material comprises between about 5 weight percent and about 99 weight percent of said abrasive diamond composite.

29. The abrasive diamond composite of claim 22, wherein said plurality of coated diamond particles comprise between about 1 volume percent and about 50 volume percent of said abrasive diamond composite.

30. The abrasive diamond composite of claim 29, wherein said plurality of coated diamond particles comprise between about 5 volume percent and about 20 volume percent of said abrasive diamond composite.

31. The abrasive diamond composite of claim 22, wherein each of said coated diamond particles has a major dimension of between about 50 microns and about 2000 microns.

32. The abrasive diamond composite of claim 31, wherein said major dimension is between about 150 microns and about 2000 microns.

33. The abrasive diamond composite of claim 32, wherein said major dimension is between about 180 microns and about 1600 microns.

34. The abrasive diamond composite of claim 22, wherein said metal M is selected from the group consisting of aluminum, silicon, scandium, titanium, vanadium, chromium, yttrium, zirconium, niobium, molybdenum, hafnium, tantalum, tungsten, rhenium, the rare earth metals, and combinations thereof.

35. The abrasive diamond composite of claim 22, wherein said protective coating has a thickness of between about 1 micron and about 50 microns.

36. The abrasive diamond composite of claim 35, wherein said thickness is between about 1 micron and about 20 microns.

37. The abrasive diamond composite of claim 36, wherein said thickness is between about 3 microns and about 15 microns.

38. An abrasive diamond composite, said abrasive diamond composite comprising:
a) a plurality of coated diamond particles, each of said coated diamond particles comprising a diamond having an outer surface and a protective coating disposed on said outer surface, said protective coating comprising a refractory material having a formula MCₓN_{y}, wherein M is a metal, C is carbon having a first stoichiometric coefficient x, and N is nitrogen having a second stoichiometric coefficient y, and wherein 0≦x, y≦2; and
b) a braze infiltrating and filling interstitial spaces between said coated diamond particles and interconnecting said coated diamond particles, wherein said protective coating protects said diamond form corrosive chemical attack by said braze material.

39. The abrasive diamond composite of claim 38, wherein said braze comprises at least one material selected from the group of copper, silver, zinc, nickel, cobalt, manganese, tin, cadmium, indium, phosphorus, gold, and palladium.

40. The abrasive diamond composite of claim 39, wherein said braze further includes at least 5 weight percent of at least one metal from the group consisting of cobalt, nickel, manganese, and iron.

41. The abrasive diamond composite of claim 38, wherein said braze comprises between about 5 weight percent and about 99 weight percent of said abrasive diamond composite.

42. An abrasive diamond composite, said abrasive diamond composite comprising:
a) a plurality of coated diamond particles, each of said coated diamond particles comprising a diamond having an outer surface and a protective coating disposed on said outer surface, said protective coating comprising a refractory material having a formula MCₓN_{y}, wherein M is a metal, C is carbon having a first stoichiometric coefficient x, and N is nitrogen having a second stoichiometric coefficient y, and wherein 0≦x, y≦2; and
b) a matrix material disposed on each of said coated diamond particles, said matrix material interconnecting said coated diamond particles and forming a skeleton structure containing a plurality of voids and open pores, said matrix material containing at least 5 weight percent of at least one metal selected from the group consisting of iron and manganese, said protective coating protecting said diamond from corrosive chemical attack by said matrix material.

43. The abrasive diamond composite of claim 42, wherein said matrix material is selected from the group consisting of iron, cobalt, nickel, manganese, steel, molybdenum, tungsten, metal carbides, mixtures thereof, and alloys thereof.

44. The abrasive diamond composite of claim 43, wherein said matrix material comprises between about 5 weight percent and about 99 weight percent of said abrasive diamond composite.

45. The abrasive diamond composite of claim 42, wherein said plurality of coated diamond particles comprises between about 1 volume percent and about 50 volume percent of said abrasive diamond composite.

46. The abrasive diamond composite of claim 45, wherein said plurality of coated diamond particles comprises between about 5 volume percent and about 20 volume percent of said abrasive diamond composite.

47. The abrasive diamond composite of claim 42, wherein each of said coated diamond particles has a major dimension of between about 50 microns and about 2000 microns.

48. The abrasive diamond composite of claim 47, wherein said major dimension is between about 150 microns and about 2000 microns.

49. The abrasive diamond composite of claim 48, wherein said major dimension is between about 180 microns and about 1600 microns.

50. The abrasive diamond composite of claim 42, wherein said metal M is selected from the group consisting of aluminum, silicon, scandium, titanium, vanadium, chromium, yttrium, zirconium, niobium, molybdenum, hafnium, tantalum, tungsten, rhenium, the rare earth metals, and combinations thereof.

51. The abrasive diamond composite of claim 42, wherein said protective coating has a thickness of between about 1 micron and about 50 microns.

52. The abrasive diamond composite of claim 51, wherein said thickness is between about 1 micron and about 20 microns.

53. The abrasive diamond composite of claim 52, wherein said thickness is between about 3 microns and about 15 microns.

54. A method for making an abrasive diamond composite for use in an abrasive tool, the method comprising the steps of:
a) providing a plurality of diamonds;
b) applying a protective coating to an outer surface of each of the diamonds, thereby forming a plurality of coated diamond particles;
c) combining a matrix material with the plurality of coated diamond particles to form a pre-form; and
d) heating the pre-form to a predetermined temperature, thereby forming the abrasive diamond composite.

55. The method of claim 54, wherein the step of applying a protective coating to an outer surface of each of the diamonds comprises depositing the protective coating using chemical vapor deposition.

56. The method of claim 54, wherein the step of applying a protective coating to an outer surface of each of the diamonds comprises depositing the protective coating using chemical transport reactions.

57. The method of claim 54, wherein the step of applying a protective coating to an outer surface of each of the diamonds comprises the steps of: depositing a metal on the outer surface of each of the diamonds; and at least one step selected from the group consisting of carburizing the metal, nitriding the metal, and a combination thereof.

58. The method of claim 54, wherein the step of combining a matrix material with the plurality of coated diamond particles comprises the steps of: mixing the plurality of coated diamond particles and the matrix material, thereby forming a mixture; and placing the mixture into a mold, thereby forming a pre-form.

59. The method of claim 54, further comprising the steps of: providing a braze alloy to the pre-form; heating the braze alloy and the pre-form to a second predetermined temperature, the second predetermined temperature being greater than a melting temperature of the braze alloy, thereby creating a molten braze alloy; and infiltrating the pre-form with the molten braze alloy.

60. The method of claim 59, wherein the step of heating the braze alloy and the pre-form to a second predetermined temperature above a melting temperature of the braze alloy comprises heating the braze alloy to a temperature in the range of between about 800° C. and about 1200° C.

61. The method of claim 54, wherein the step of heating the pre-form to a predetermined temperature comprises hot pressing the pre-form at a predetermined temperature and a predetermined pressure.

62. The method of claim 61, wherein the predetermined temperature is in the range of between about 600° C. and about 1100° C., and the predetermined pressure is in the range of between about 1,000 psi and about 20,000 psi.

63. The method of claim 62, wherein the predetermined temperature is in the range of between about 750° C. and about 900° C., and the predetermined pressure is in the range of between about 4,000 psi and about 6,000 psi.

64. The method of claim 54, wherein the step of heating the pre-form to a predetermined temperature comprises free-sintering the matrix material at a temperature below a melting point of the matrix material.

65. A method for making a liquid-infiltrated abrasive diamond composite for use in an abrasive tool, the method comprising the steps of:
a) providing a plurality of diamonds;
b) applying a protective coating to an outer surface of each of the diamonds, thereby forming a plurality of coated diamond particles;
c) combining a matrix material with the plurality of coated diamond particles to form a pre-form in which the matrix material forms a skeleton structure containing a plurality of voids and open pores;
d) placing a braze alloy in contact with the pre-form;
e) heating the braze alloy and the pre-form to a predetermined temperature above a melting temperature of the braze alloy, thereby creating a molten braze alloy; and
f) infiltrating the molten braze alloy through the matrix material and occupying the plurality of voids and open pores with the molten braze alloy, thereby forming the liquid-infiltrated abrasive diamond composite.

66. The method of claim 65, wherein the step of heating the braze alloy and the pre-form to a predetermined temperature above a melting temperature of the braze alloy comprises heating the braze alloy to a temperature in the range of between about 800° C. and about 1200° C.

67. The method of claim 65, further including the step of resolidifying the molten braze alloy.
